(19) United States
(12) Patent Application Publication
(10) Pub. No.: US 2017/0028243 A1
(43) Pub. Date: Feb. 2, 2017

(54) ELASTIC PULL ROPE FOR USE IN EXERCISE

(71) Applicants: TUNG HUI CHUANG, TAINAN CITY (TW); SHENG KAI CHUANG, TAINAN CITY (TW)

(72) Inventors: TUNG HUI CHUANG, TAINAN CITY (TW); SHENG KAI CHUANG, TAINAN CITY (TW)

(21) Appl. No.: 15/013,048

(22) Filed: Feb. 2, 2016

(30) Foreign Application Priority Data
Jul. 31, 2015 (TW) 104212337

(51) Int. Cl. A63B 21/055; B29C 47/06; B29C 47/00; A63B 23/12

(52) U.S. Cl. CPC A63B 21/0555; A63B 23/12; B29C 47/065; B29C 47/0064; B29L 2023/00

(57) ABSTRACT

The present invention relates to an elastic pull rope used in exercise, comprising an inner tube layer with a hollow channel, a woven wire layer surrounding the outer part of the inner tube layer and an outer tube layer surrounding the outer part of the woven wire layer, wherein the woven wire layer surrounds the outer surface of the inner tube layer via a plurality of first wire rods, and weaving a plurality of second wire rods around the first wire rods in an overlapping manner in order to form and clamp the woven wire layer between the inner and outer tube layers, so that the formed elastic pull rope would have improved overall structural strength.

### FIELD OF THE INVENTION

The present invention relates to an elastic pull rope used in exercise, and particularly relates to placing a woven wire layer formed of wire rods between an inner tube layer and an outer tube layer, so that the woven wire layer would improve the tensile elasticity and the overall structural strength of the elastic pull rope.

### DESCRIPTION OF THE RELATED ART

Recently, elastic pull ropes of pull exercisers are placed between two grips in order to enable fitness users to hold the grips with two hands and repeatedly perform the actions of drawing and extending the elastic pull rope length and releasing and recovering the elastic pull rope length, thereby achieving the effect of training the chest and arm muscles.

Conventional elastic pull ropes are in the form of hollow pipes made of latex, thermoplastic resin (TPR) etc. materials, and therefore, they can easily be oxidized and have brittle rupture problems. Especially, while holding exercise fitness equipment, the elastic pull ropes can be frequently bundled/rolled, which may cause formation of break angles at the points of bending. Since the break angles can easily be oxidized, therefore the elastic pull rope may be broken at a break angle position during use, and may even cause safety problems such as the broken elastic pull rope hitting the user.

In order to improve the above described drawback, U.S. Pat. No. 9,216,313 discloses an “elastic cord”, in which the hollow outer elastic cord comprises a first end and a second end spaced from the first end in a longitudinal direction; an outer periphery positioned at the outer periphery of the hollow outer elastic cord, and an inner periphery spaced from the outer periphery in a radial direction perpendicular to the longitudinal direction; a rib extending from the inner periphery, the longitudinal hole of the rib passing through and extending from the first end through the second end of the hollow outer elastic cord; an elastic string received in the longitudinal hole of the rib, the two ends of the elastic string being respectively located in the first and second ends of the hollow outer elastic cord, and the elastic string having a maximal elongation larger than a maximal elongation of the hollow outer elastic cord; so that the hollow outer elastic cord would ensure safety of the pull rope during exercise.

U.S. Pat. No. 7,827,895, entitled: “Safety elastic rope” comprises an elastic outer tubular rope having two longitudinally opposite first fixing ends; an elastic inner rope inserted into said outer tubular rope and having two longitudinally opposite second fixing ends; wherein said elastic inner rope is more elastic than said elastic outer tubular rope, said second fixing ends being connected respectively to said first fixing ends; so that the elastic outer tubular rope prevents the elastic inner rope from extensive drawing and breaking.

Also, Republic of China patent No M265065, entitled: “Elastic Pull Rope Structure Used in Exercise” relates to an elastic pull rope knitted by a circular knitting machine, comprising: in order to reduce the wear caused on the elastic pull rope during drawing and releasing the elastic pull rope structure during exercise, the structure mainly comprises an elastic pull rope tubular body outer edge having elastic characteristics, and via knitting by the circular knitting machine, a woven outer layer can be obtained, which ensures that, during drawing and releasing of the elastic pull rope, even though surface layers collide, direct wear between the tubular bodies would not occur, and thus reduces the wear and tear and therefore rupture of the tubular bodies.

Also, Republic of China Patent No 1365085, entitled “Elastic Pull Rope Comprising Inner Safety Rope” comprises two fixed end points, an elastic outer rope, two ends of which are connected to the fixed end points, and an inner safety rope. The inner safety rope is elastic and the inner safety rope is passed through the elastic outer rope, and therefore, the elastic pull rope exterior is improved, and the product applicability of the elastic pull rope is also improved as well as maintaining the application safety of the product.

### SUMMARY OF THE INVENTION

The present invention relates to the problem of formation of buckling break angles, oxidation, and brittle rupture of conventional elastic pull ropes due to bundling/rolling movement while holding, which leads to the risk of being broken at the break angles, and even hurting the user.

Therefore, the purpose of the present invention is to place a woven wire layer between an inner tube layer and an outer tube layer, so that the woven wire layer would improve the tensile elasticity and the overall structural strength of the elastic pull rope.

In order to achieve the above said purpose, the present invention provides an elastic pull rope used in exercise, comprising: an inner tube layer comprising a hollow channel; a woven wire layer, surrounding the outer part of the inner tube layer in the form of a plurality of first wire rods surrounding the annular surface of the inner tube layer and a plurality of second wire rods woven on the first wire rods in a surrounding and overlapping manner, and the overlapping angle of the first wire rods and the second wire rods is smaller than 90 degrees; and an outer tube layer surrounding the outer part of the woven wire layer.

Accordingly, the first wire rods and the second wire rods individually surround the inner tube layer outer part, and the second wire rods overlap the first wire rods to form a woven wire layer structure, and by means of the outer tube layer, the woven wire layer being clamped and covered in between the outer tube layer and the inner tube layer, the elastic pull rope structure formed can improve the tensile elasticity and overall structural strength of the elastic pull rope via the woven wire layer, so that it can prevent problems during use of the elastic pull rope in exercise, such as the rope body of the elastic pull rope being broken/ruptured and then hitting the user, and thus reduces accident risk. Besides, when the exercise tool is not needed to be used, due to the positioning of the inner tube layer and the outer tube layer, the elastic pull rope would not cause break angle problem if carried by bending or rolling. Therefore, the problems of oxidizing and brittle rupture and thus breaking due to break angle of the conventional elastic pull ropes would be solved.

### BRIEF DESCRIPTION OF THE DRAWINGS

FIG. 1 is a three dimensional view of the elastic pull rope of the present invention.

FIG. 2 is a schematic view of the elastic pull rope structure of the present invention.

FIG. 3 is a schematic view of the woven wire layer of the present invention.

FIG. 4 is a schematic view of the elastic pull rope of the present invention during use.

FIG. 5 is a schematic view of the production steps of the elastic pull rope of the present invention.

FIGS. 6-7 are schematic views showing the production of the woven wire layer of the present invention.

FIGS. 8-9 are schematic views showing the production of the outer tube layer of the present invention.

### DETAILED DESCRIPTION OF THE PREFERRED EMBODIMENTS

The characteristics and technical contents of the present invention shall be understood more clearly with the below given detailed description of the preferred embodiments, together with the attached figures.

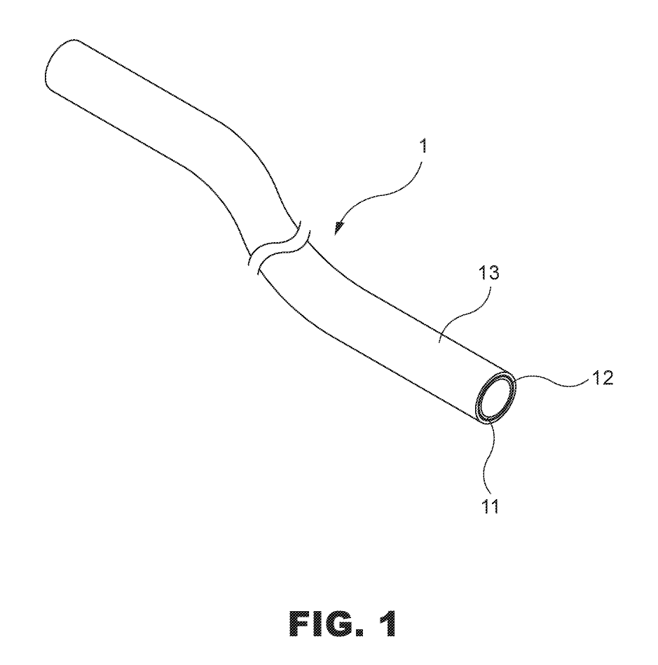

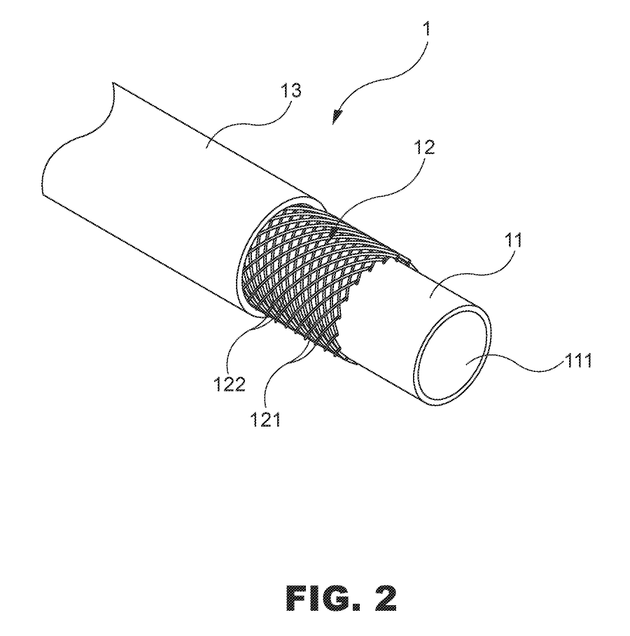

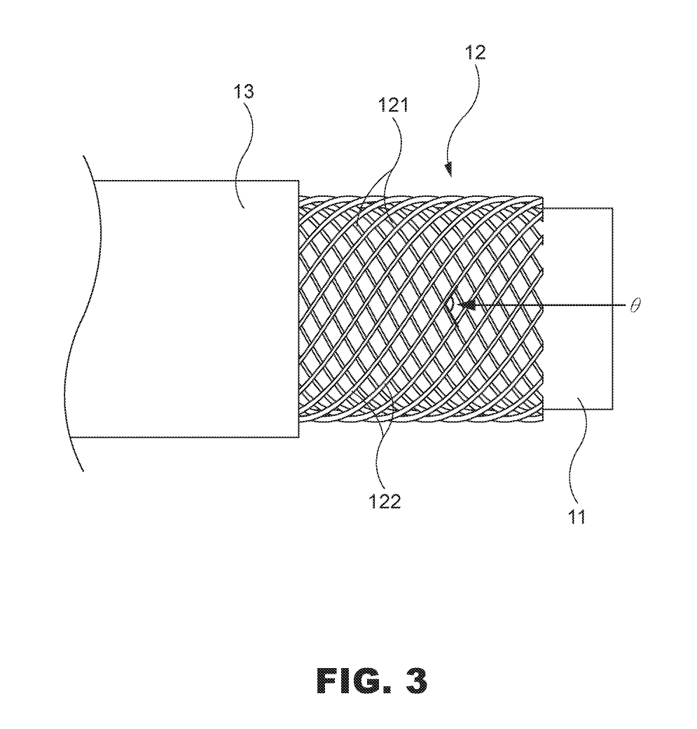

First of all, according to FIG. 1 and FIG. 2, the elastic pull rope 1 comprises an inner tube layer 11, a woven wire layer 12, and an outer tube layer 13. The inner tube layer 11 comprises a hollow channel 111, and in an embodiment of the present invention, the inner tube layer 11 is made of latex or thermoplastic resin material. The woven wire layer 12 surrounds the outer part of the inner tube layer 11 in the form of a plurality of first wire rods 121 surrounding the annular surface of the inner tube layer 11 and plurality of second wire rods 122 woven on the first wire rods 121 in a surrounding and overlapping manner. Also, the overlapping angle θ of the first wire rods 121 and the second wire rods 122 is smaller than 90 degrees (see, FIG. 3). In an embodiment of the present invention, the first wire rods 121 and the second wire rods 122 of the woven wire layer 12 are not made of metal, and instead, they are made of nylon thread, cotton thread, or polyester fiber thread. Moreover, the woven wire layer 12 is made of one of or a blend of two or three kinds of wires woven from nylon thread, cotton thread, and polyester fiber thread. Also, the optimum θ angle for overlapping of the first wire rods 121 and the second wire rods 122 is between 60-70 degrees. The outer tube layer 13 surrounds the outer part of the woven wire layer 12. And in an embodiment of the present invention, the outer tube layer 13 is made of latex or thermoplastic resin material.

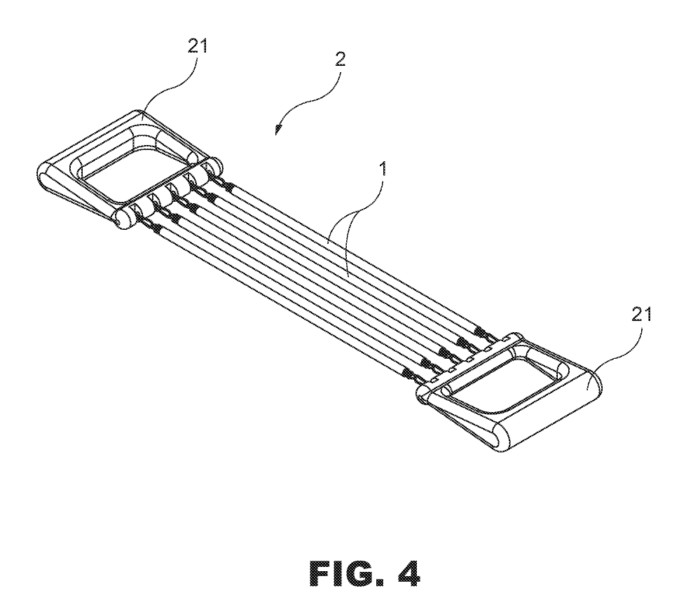

In the second place, according to FIG. 4, a schematic view of the elastic pull rope of the present invention is usage state. During use, the elastic pull ropes 1, placed between two grips 21 of pull exercisers 2, enable users to hold the grips 21 with two hands and repeatedly perform the actions of drawing and extending the elastic pull rope 1 length and releasing and recovering the elastic pull rope 1 length, thereby achieving the effect of training the chest and arm muscles.

The outer tube layer 13 of the pull exerciser 2 and its elastic pull rope 1 can easily be ruptured due to tension after using the tool for a while, and in this situation, the rope structure of the elastic pull rope 1 can be kept intact by means of using an inner tube layer 11 and a woven wire layer 12. Moreover, if the inner tube layer 11 and the outer tube layer 13 are ruptured at the same time due to tension, complete rupture of the rope structure of the elastic pull rope 1 can be avoided by using a woven wire layer 12. At the same time, the woven wire layer 12 can be used with first wire rods 121 and second wire rods 122 having an overlapping degree θ (see, FIG. 3). In order to adjust the drawing range of the elastic pull rope 1, when the overlapping angle between the first wire rods 121 and the second wire rods 122 is larger, the draw length of the woven wire layer 12 between the inner tube layer 11 and the outer tube layer 13 is longer, and therefore, by means of adjusting the overlapping angle θ between the first wire rods 121 and the second wire rods 122, adequate space can be provided for the woven wire layer 12 to get longer between the inner tube layer 11 and the outer tube layer 13. Also, the draw length between the inner tube layer 11 and the outer tube layer 13 can be relatively restricted in order to prevent excessive drawing and causing the inner tube layer 11 or the outer tube layer 13 to rupture.

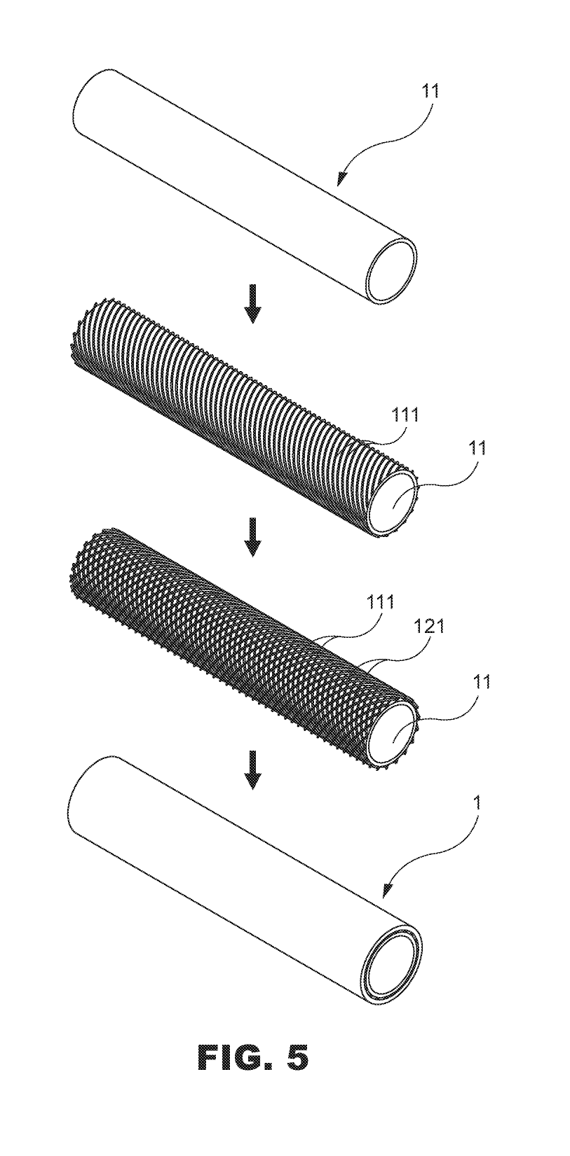

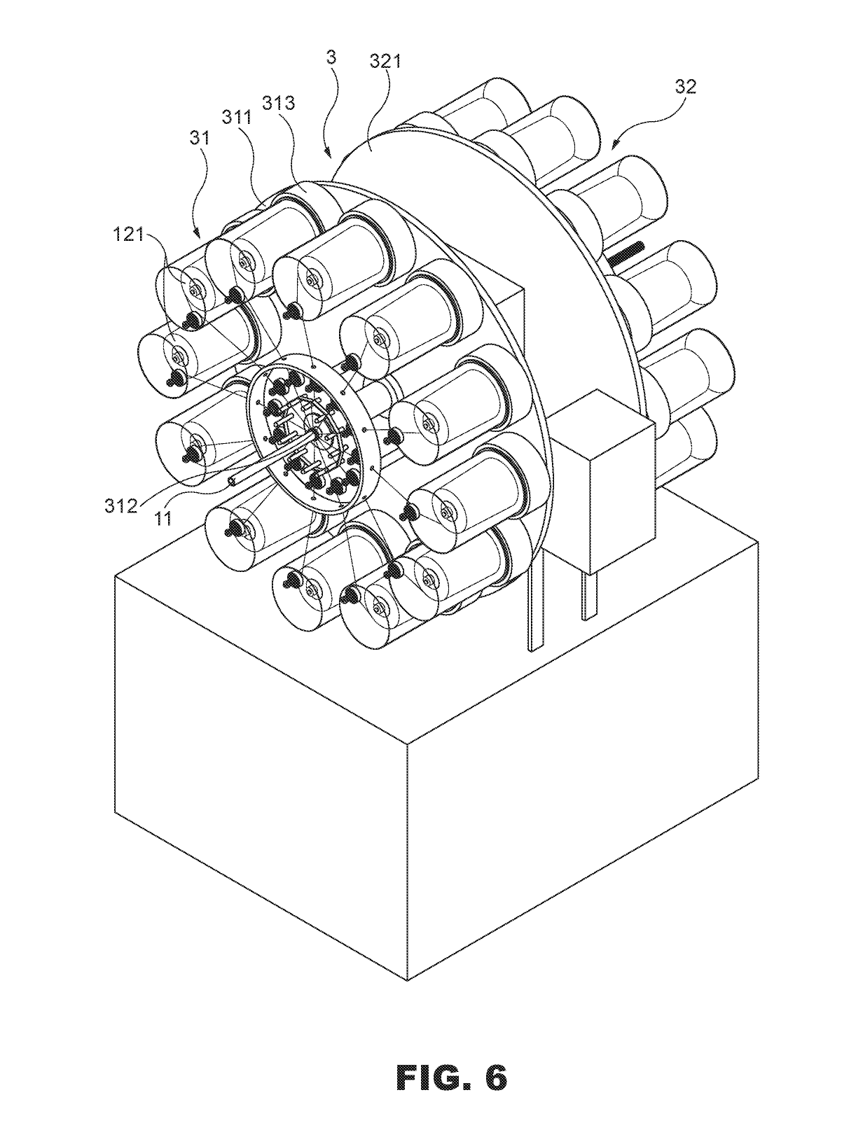

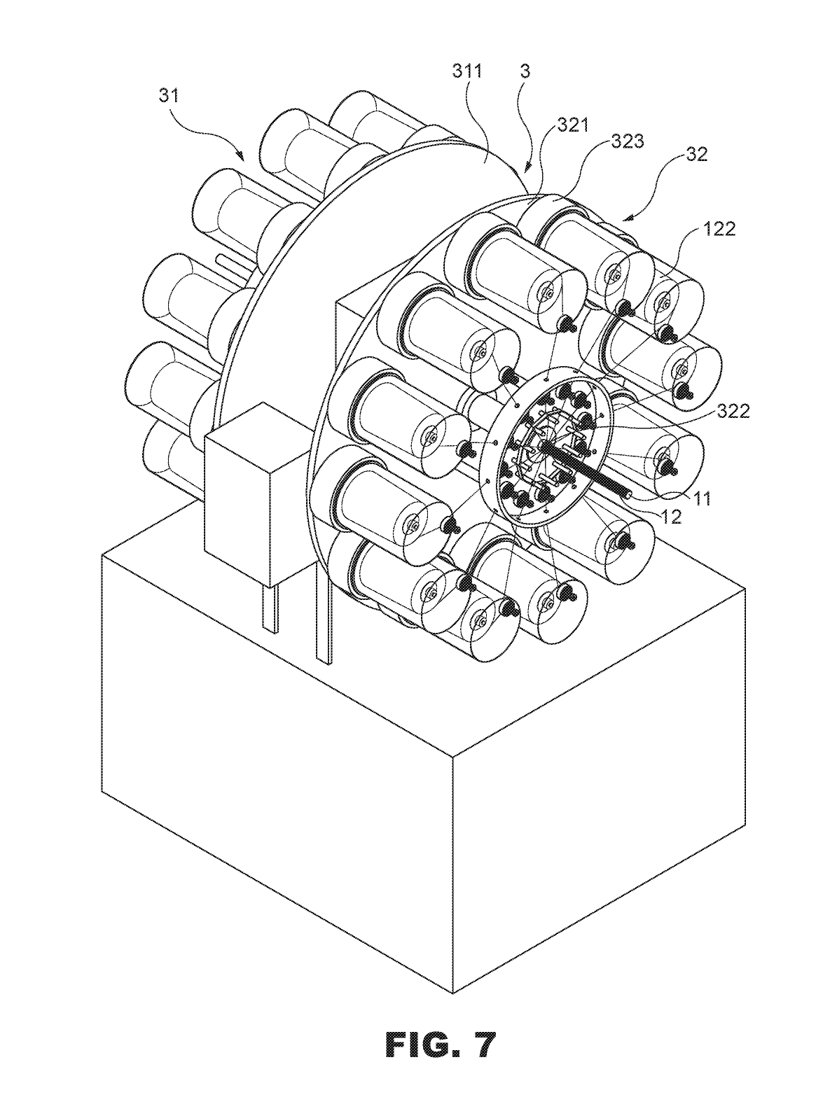

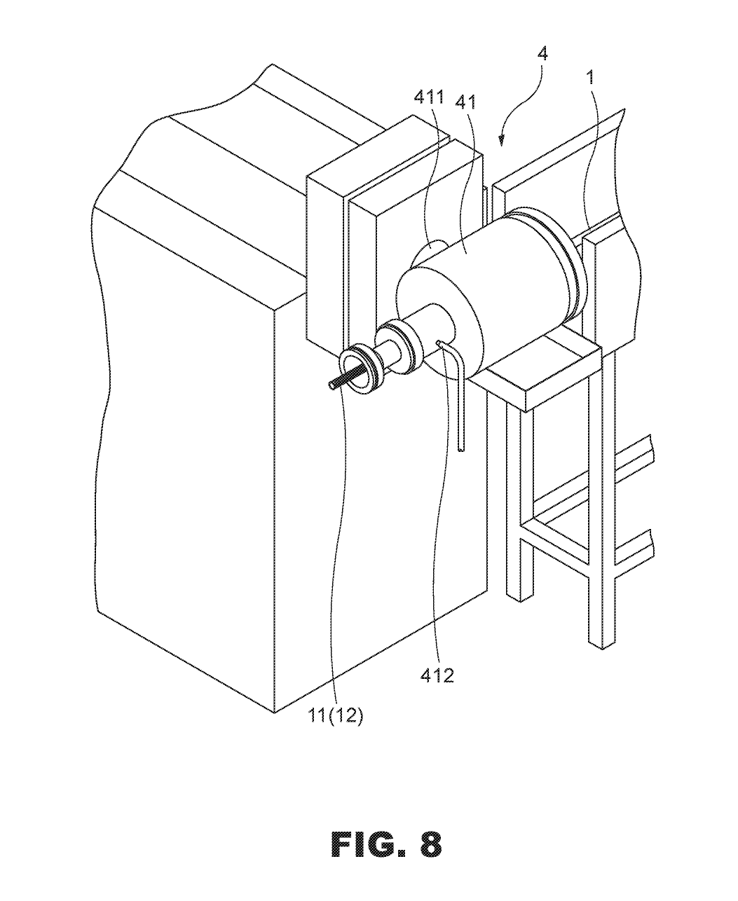

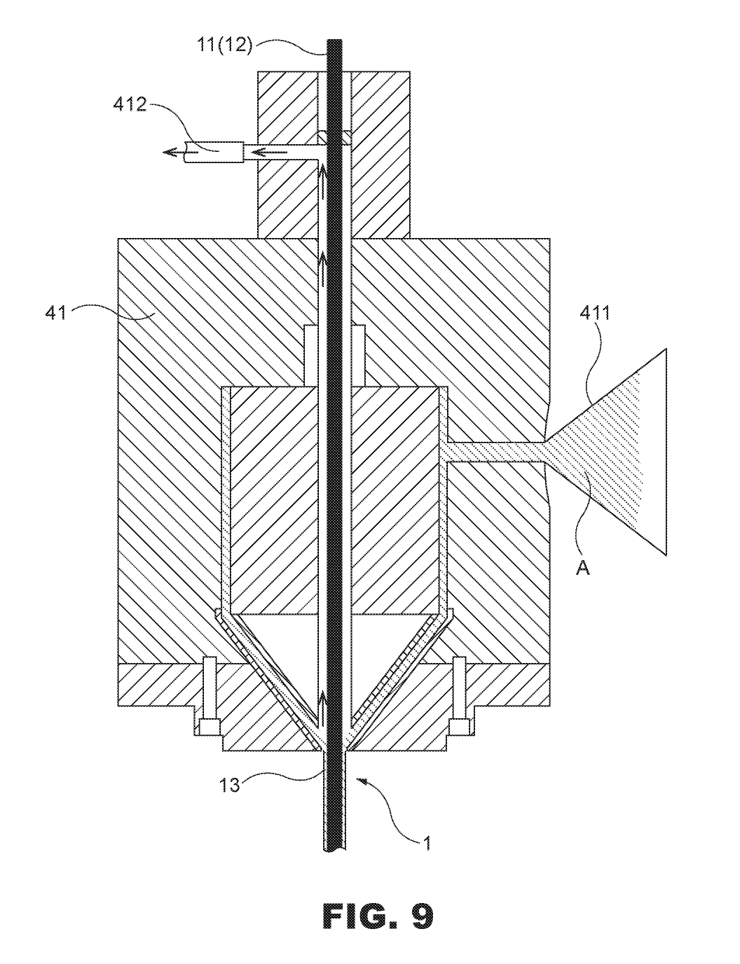

In FIG. 5, a schematic view of the production steps of the elastic pull rope according to the present invention is given. During production of the elastic pull rope 1, first of all, an inner tube layer 11 having a hollow channel is formed by extruding in an extruder, and then the inner tube layer 11 is placed in a braiding machine 3 (See, FIGS. 6-7). The braiding machine 3 comprises a first weaving device 31 and a second weaving device 32 in the front and rear, respectively. Also, the first weaving device 31 and the second weaving device 32 comprise on their fixed plates 311 (321) connected axial tubes 312 (322), and the fixed plate 311 and fixed plate 321 individually have a plurality of distributed reels 313 (323) for the first wire rods 121 and the second wire rods 122. After the inner tube layer 11 enters into the axial tube 312 of the first weaving device 31, the plurality of reels 313 distributed over the fixed plate 311 surround the outer periphery of the inner tube layer 11 in an equally spaced manner. Afterwards, the inner tube layer 11 surrounded by the first wire rods 111 come out through the axial tube 322 of the fixed plate 321 on the second weaving device 32, and at the same time, the plurality of reels 323 distributed on the fixed plate 321 surround and overlap on the first wire rods 111 in an equally spaced manner. As a result, the outer surface of the inner tube layer 11 takes the form of a woven wire layer 12 having the first wire rods 121 and the second wire rods 122 in an overlapping structure. After the weaving of the inner tube layer 11 is finished, it is placed into the mould 41 of the extruder 4 (see, FIGS. 8-9), and the extruded raw material A comes out through the extruded material outlet 411 in the form of an outer tube layer 13 surrounding the inner tube layer 11 and the woven wire layer 12. Also, an extract opening 412 found in the mould 41 draws out the gases found between the inner tube layer 11 and the outer tube layer 13, so that the outer tube layer 13 would be in a vacuum state and tightly cover the outer periphery of the inner tube layer 11 and the woven wire layer 12 and form the elastic pull rope 1 structure. It is worth mentioning that, the extruder 4 of the present invention comprises an extract opening 412 on its mould 41, the extract opening 412 is connected to an air extractor and can perform air extraction through the extract opening, so that the raw material A found in the mould would present a vacuum state and provide tight adsorption and cover the outer part of the inner tube layer 11 and the woven wire layer 12. In this way, the prior art way of forming the outer tube layer 13 via extrusion is avoided, in which the elastic pull rope 1 can easily be drawn out and be too fast or too slow compared to the speed of the mould 41, causing the outer tube layer 13 be too thick or too thin.

According to the descriptions of the above given embodiments, it can be understood that the elastic pull rope used for exercise according to the present invention provides the below given improvements:
1. The elastic pull rope of the present invention comprises first wire rods and second wire rods individually surrounding the inner tube layer outer part, and the second wire rods overlapping the first wire rods to form a woven wire layer structure, and by means of the outer tube layer, the woven wire layer being clamped and covered in between the outer tube layer and the inner tube layer, and thus the elastic pull rope structure formed can improve the tensile elasticity and overall structural strength of the elastic pull rope via the woven wire layer, so that it can prevent problems during use of the elastic pull rope in exercise, such as the rope body of the elastic pull rope being broken/ruptured and then hitting the user, and thus reduces accident risk.
2. When the exercise tool of the present invention is not needed to be used, due to the positioning of the inner tube layer and the outer tube layer, the elastic pull rope would not cause break angle problem if carried by bending or rolling, and therefore, the problems of oxidizing and brittle rupture and thus breaking due to break angle of the conventional elastic pull ropes would be solved.
3. The extruder mould used for producing the outer tube layer of the elastic pull rope according to the present invention comprises an extract opening for drawing out the air found between the outer tube layer and the inner tube layer during formation of the outer tube layer inside the mould via extraction of the raw materials. In this way, the outer tube layer can have vacuum state and ensure tight covering/wrapping around the inner tube layer and the woven wire layer. As a result, the prior art problem of forming the outer tube layer too thin or too thick due to formation of the outer tube layer via extrusion would be solved.

In conclusion, in the elastic pull rope according to the present invention, by means of placing/clamping the woven wire layer in between the inner tube layer and the outer tube layer, the structural strength of the elastic pull ropes are improved significantly, and therefore, the problems of oxidizing and brittle rupture and thus breaking due to break angle of the conventional elastic pull ropes are solved, which is in accordance with novelty, inventive step, and industrial applicability criteria of patents.

What is claimed is:

1. An elastic pull rope for use in exercise, comprising:
an inner tube layer comprising a hollow channel;
a woven wire layer, surrounding the outer part of the inner tube layer in the form of a plurality of first wire rods surrounding the annular surface of the inner tube layer and a plurality of second wire rods woven on the first wire rods in a surrounding and overlapping manner, and the overlapping angle of the first wire rods and the second wire rods is smaller than 90 degrees; and
an outer tube layer surrounding the outer part of the woven wire layer.

2. The elastic pull rope for use in exercise according to claim 1, wherein, the inner tube layer and the outer tube layer are made of latex or thermoplastic resin material.

3. The elastic pull rope for use in exercise according to claim 1, wherein, the first wire rod and the second wire rod are not metal.

4. The elastic pull rope for use in exercise according to claim 1, wherein, the first wire rods and the second wire rods are made of nylon thread, cotton thread, or polyester fiber thread.

5. The elastic pull rope for use in exercise according to claim 1, wherein, the first wire rods and the second wire rods are made of one of or a blend of two or three kinds of wires woven from nylon thread, cotton thread, and polyester fiber thread.

6. The elastic pull rope for use in exercise according to claim 1, wherein, the overlapping angle of the first wire rods and the second wire rods is between 60-70 degrees.

7. The elastic pull rope for use in exercise according to claim 1, wherein, the elastic pull rope production method comprises the steps of:
(a) extrusion forming an inner tube layer with a hollow channel;
(b) placing the inner tube layer in a braiding machine and surrounding the outer surface of the inner tube layer with a plurality of first wire rods;
(c) surrounding a plurality of second wire rods around the first wire rods in an overlapping manner, so that a woven wire layer would be formed around the outer surface of the inner tube layer; and
(d) placing the inner tube layer having the woven wire layer into a mould of an extruder, so that extruded raw materials would be come out from the extruded material outlet and form the outer tube layer surrounding the inner tube layer and the woven wire layer, and also, drawing out the gases found between the inner tube layer and the outer tube layer by means of an extract opening found in the mould, so that the outer tube layer would be in a vacuum state and tightly cover the outer periphery of the inner tube layer and the woven wire layer and form the elastic pull rope structure.

8. The elastic pull rope for use in exercise according to claim 7, wherein, the inner tube layer and the outer tube layer are made of latex or thermoplastic resin material.

9. The elastic pull rope for use in exercise according to claim 7, wherein, the first wire rod and the second wire rod are not metal.

10. The elastic pull rope for use in exercise according to claim 7, wherein, the first wire rods and the second wire rods are made of nylon thread, cotton thread, or polyester fiber thread.

11. The elastic pull rope for use in exercise according to claim 7, wherein, the first wire rods and the second wire rods are made of one of or a blend of two or three kinds of wires woven from nylon thread, cotton thread, and polyester fiber thread.

12. The elastic pull rope for use in exercise according to claim 7, wherein, the overlapping angle of the first wire rods and the second wire rods is between 60-70 degrees.
